(19) United States
(12) Patent Application Publication
(10) Pub. No.: US 2006/0047134 A1
(43) Pub. Date: Mar. 2, 2006

(54) Process for the production of (trimethylsilyloxy)silylalkylglycerol methacrylates

(76) Inventors: Frank Molock, Orange Park, FL (US); Shivkumar Mahadevan, Orange Park, FL (US); Robert S. Ward, Lafayette, CA (US); Shanger Wang, Fairfield, CA (US); James Paul Parakka, San Bruno, CA (US); Yuan Tian, Alameda, CA (US)

Correspondence Address: PHILIP S. JOHNSON;JOHNSON & JOHNSON, ONE JOHNSON & JOHNSON PLAZA, NEW BRUNSWICK, NJ, 08933-7003, US

(21) Appl. No.: 10/926,425

(22) Filed: Aug. 25, 2004

(51) Int. Cl. C07F 7/04

(52) U.S. Cl. 556/446

(57) ABSTRACT

The present invention relates to a process comprising the steps of reacting in the presence of a hydrosilylation catalyst, a first reaction mixture comprising a free radical reactive compound and a silicon containing compound to form a silicon substituted glyceryl (meth)acrylate.

### FIELD OF THE INVENTION

The present invention relates to processes for the production of silicone monomers and particularly (trimethylsilyloxy)silylalkyl glycerol methacrylates.

### BACKGROUND OF THE INVENTION

Various silicone containing monomers have found utility as starting materials in the production of medical devices, such as ophthalmic devices and particularly, soft contact lenses having improved permeability to oxygen. One class of suitable monomers includes tris and bis(trimethylsilyloxy)silylalkylglycerol methacrylates (“SiAGMA”). Processes for the production of substituted and unsubstituted silicone glycerol acrylates via the reaction of a silicone with an epoxide are known. However, the silicon-oxygen bond is labile and migration of trimethylsilyl ethers to and between hydroxyl groups yields several unwanted side reactions, which produce large amounts of unwanted byproducts. Several of these byproducts have significant impacts on the properties of resulting silicone substituted glycerol acrylate, which can impact their ability to be used as raw materials in medical devices such as contact lenses.

One process for making SiAGMA includes reacting the epoxide of the SiAGMA with methacrylic acid and either the sodium, potassium or lithium salt of methacrylic acid and an inhibitor, such as hydroquinone monomethyl ether. Reaction conditions include heating for about 15 hours, and yields SiAGMA having a purity of between about 75 to 95% and a number of byproducts, including dimethacrylated byproducts. When included in the monomer mixes used to make ophthalmic devices such as contact lenses, the dimethacrylated byproducts can act as crosslinkers, which even in small quantities can change the modulus of the resulting device. Accordingly, the concentration of these difunctional byproducts must either be tightly controlled or minimized. Removal of the difunctional byproducts is conventionally done by a cumbersome silica gel column chromatography step.

Thus, there remains in the art for an improved process for the production of silicone substituted glyeryl acrylates, such as SiAGMA type compounds.

### SUMMARY OF THE INVENTION

The present invention relates to a process comprising the steps of reacting, in the presence of a hydrosilylation catalyst, a first reaction mixture comprising a free radical reactive compound and a silicon containing compound of the formula
HSiR²R³R⁴
wherein R², R³ and R⁴ are independently selected from alkyl or alkyloxy groups having 1 to 16 carbons, substituted and unsubstituted aromatic groups, and 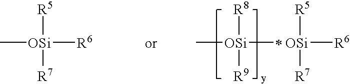
   wherein R⁵, R⁶ R⁷, R⁸ and R⁹ are independently selected from the group consisting of straight or branched alkyl groups having 1 to 16 carbon atoms and substituted or unsubstituted phenyl or benzyl rings to form a first reaction product comprising silicone substituted glyceryl (meth)acrylate and treating said first reaction product to remove compounds which are more polar than said silicon substituted glyceryl (meth)acrylate.

### DESCRIPTION OF THE INVENTION

In the first step of the present invention at least one free radical reactive compound and a silicon containing compound are reacted in the presence of a hydrosilylation catalyst. Suitable free radical reactive compounds include 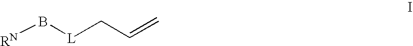
wherein R^{N} is selected from moieties having the formulae II and III: 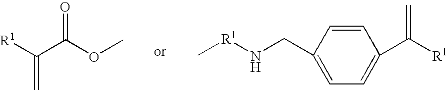
B is a group which can hydrogen bond with another moiety or a carboxylic acid derivative. Specific examples for B include carbonyl, alkylene having 1 to 6 carbon atoms which may be unsubstituted or substituted with hydroxy, amines, amides, ethers, esters, aldehydes, ketones, aromatics, alkyl groups and combinations thereof.
L is a linking group selected from a direct bond, hetero atoms and straight or branched alkylenes having 1 to 6 carbon atoms. Preferably L is a hetero atom selected from O, N or S. Preferably B is a hydroxyl substituted alkyl group having 1-4 carbon atoms. R¹ may be the same or different, and is independently selected from H and alkyl groups having 1 to 4 carbon atoms. The substituted or unsubstituted free radical reactive compounds are present in the first reaction mixture in amounts between about 75 and about 150 mole % of the silicon containing compound.

The free radical reactive compounds may be formed by reacting at least one substituted epoxide with at least one nucleophilic compound in the presence of at least one epoxide opening catalyst. Suitable nucleophilic compounds include those that are capable of opening the epoxide to form a compound having a free hydroxyl group. Examples of nucleophilic compounds include, but are not limited to amines, alcohols, carboxylates, thiols, combinations thereof and the like. Suitable nucleophilic compounds preferably include (meth)acrylic acids comprising between 1 and 4 carbon atoms and 4-aminostyrene. Preferably said nucleophilic compound is methacrylic acid. The reaction between the epoxide and the acrylic acid may performed at ratios of between about 0.5 to about 1 moles of nucleophilic compound per mole epoxide.

Suitable epoxides include monosubstituted epoxides having a terminal vinyl group. Specific examples include epoxides of formula IV 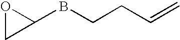
where B and L are as defined above. A specific example includes allyl glycidyl ether.

The epoxide opening catalyst may be any catalyst which is known in the art to open the epoxide ring. Suitable epoxide opening catalysts include Lewis acids, Lewis bases, Bronsted acids and porphyrin complexes, combinations thereof and the like. A preferred class of epoxide opening catalysts include alkali metal salts of acrylic acids and amine catalysts, such as pyridine, pyrazine, pyridazine, pyrimidine, triazine, quinoline, imidazole, triethylamine, tributylamine, dimethylaminopyridine, DABCO, DBU, DBN, and other aromatic or aliphatic tertiary amines. Suitable alkali metals include Li and K and Na and suitable acrylic acids comprise between one and four carbon atoms. Preferably said alkali metal salt is the Li or Na salt of methacrylic acid, and most preferably the Li salt. The epoxide opening catalyst is added in an amount sufficient to catalyze the reaction, and preferably in molar ratios ranging from about 0.05 to about 0.5 moles of epoxide opening catalyst per mole nucleophilic compound.

An inhibitor may also be included with the reactants. Any inhibitor which is capable of reducing the rate of polymerization may be used. Suitable inhibitors include hydroquinone monomethyl ether, butylated hydroxytoluene, mixtures thereof and the like. The inhibitor may be added in an amount up to about 15,000 ppm, and preferably in an amount between about concentrations ranging from 4000 to 15000 ppm based on weight of nucleophilic compound.

Suitable temperatures include elevated temperatures, preferably greater than about 60° C. and more preferably between about 80° C. and about 110° C. Suitable reaction times include up to about 30 hours, preferably between about 15 and about 30 hours. It will be appreciated by those of skill in the art the temperature and reaction time are inversely proportional, and that higher reaction temperatures may allow for decreased reaction times and vice versa.

The resulting free radical reactive compound may be purified by various means, such as extraction with solvents such as methyl ethyl ketone, ethyl acetate, ether, acetonitrile, hexane solvent mixtures and mixtures thereof. Solvent extraction may be followed by molecular distillation using equipments such as the falling film evaporator, wiped film evaporator, spinning disk molecular still and the like.

Suitable silicon containing compounds include compounds of the formula V: 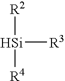
wherein R², R³ and R⁴ are independently selected from alkyl or alkyloxy groups having 1 to 16 carbons, substituted and unsubstituted aromatic groups, and 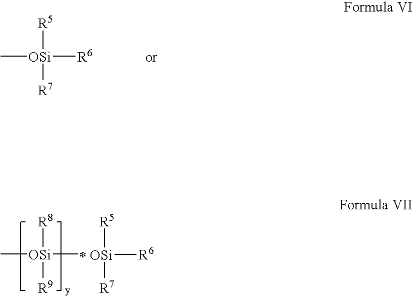
wherein R⁵, R⁶R⁷, R⁸ and R⁹ are independently selected from the group consisting of straight or branched alkyl groups having 1 to 16 carbon atoms and substituted or unsubstituted phenyl or benzyl rings and y is an integer from 1 to 25, preferably from 1 to 15. In a preferred embodiment at least one of R², R³ and R⁴, is a siloxane of Formula VI or VII and more preferably, at least two of R², R³ and R⁴ is a siloxane of Formula VI or VII. Preferred R², R³ and R⁴ groups are independently selected from alkyl groups having 1-4 carbon atoms, phenyl and siloxane groups of Formula VI or VII where R⁵, R⁶ R⁷, R⁸ and R⁹ are independently selected from alkyl groups having 1-4 carbon atoms and phenyl groups. Particularly preferred R², R³ and R⁴ groups are independently selected from methyl, ethyl, phenyl and (trimethyl)siloxy, Specific examples of suitable silicon containing compounds include heptamethyltrisiloxane, tris(trimethylsiloxy) silane, pentamethyldisiloxane, and the like. The silicon containing compounds are present in the reaction mixture in amounts between about 75 and about 150 mole % of the free radical reactive compound, and preferably about 90 to about 150 mole % of the free radical reactive compound.

The free radical reactive compound and silicon containing compound are reacted in the presence of a hydrosilylation catalyst. Suitable hydrosilylation catalysts include metal halides, including chlorides, bromides and iodides of chromium, cobalt, nickel, germanium, zinc, tin, mercury, copper iron, ruthenium, platinum, antimony, bismuth, selenium and tellurium. Specific examples of suitable hydrosilylation catalysts include platinum alone, catalysts composed of solid platinum on carriers such as alumina, silica and carbon black, chloroplatinic acid, complexes of chloroplatinic acid with alcohols, aldehydes and ketones, platinum-olefin complexes {for example, Pt(CH₂═CH₂)₂(PPh₃)₂Pt(CH₂═CH₂)₂Cl₂}; platinum-vinyl siloxane complexes {for example, Ptn(ViMe₂SiOSiMe₂Vi)ₘ, Pt[(MeViSiO)₄]ₘ}; platinum-phosphine complexes {for example, Pt(PPh₃)₄, Pt(PBu₃)₄}; platinum-phosphite complexes {for example, Pt[P(OPh)₃]₄, Pt[P(OBu)₃]₄} (in which formulas, Me is a methyl group, Bu is a butyl group, Vi is a vinyl group, Ph is a phenyl group and n and m are integers), dicarbonyl dichloroplatinum, platinum-hydrocarbon complexes as described in U.S. Pat. No. 3,159,601 and U.S. Pat. No. 3,159,662 and platinum-alcoholate catalysts as described in U.S. Pat. No. 3,220,972. In addition, platinum chloride-olefin complexes as described in U.S. Pat. No. 3,516,946 are useful. Examples of catalysts other than platinum compounds that can also be used include RhCl(PPh₃)₃, RhCl₃, Rh/Al₂O₃, RuCl₃, IrCl₃, FeCl₃, AlCl₃, PdCl₂≅2H₂O, NiCl₂ and TiCl₄ (Ph indicating a phenyl group). Preferred hydrosilation catalysts include chlorides of platinum, and vinyl complexes of platinum such as Karstedt's and Ashby's catalysts and a particularly useful hydrosilation catalyst is chloroplatinic acid.

The hydrosilylation catalyst is used in amounts between about 5 and about 500 ppm, and preferably about 10 and about 100 ppm.

The reaction is conducted under mild conditions, such as temperatures between about 0 to about 100° C., preferably between about −20° and about 60° C., and more preferably from about −10 to about 30° C. It has been found that these reaction temperatures reduce by-products by an appreciable amount even if the time of reaction is increased. Pressure is not critical, and atmospheric pressure may be used. Reaction times of up to about 24 hours, preferably up to about 12 hours and more preferably between about 4 and about 12 hours may be used. It will be appreciated by those of skill in the art the temperature and reaction time are inversely proportional, and that higher reaction temperatures may allow for decreased reaction times and vice versa. However, in the process of the present invention it is desirable to run the reaction to or near completion (for example, greater than about 95% conversion of the silicone containing compound or the silicon containing compound depending on which compound is used in a molar excess).

The components may be mixed neat (without solvent) or in solvents, such as aliphatic hydrocarbons, aromatic hydrocarbons, ethers, ketones, mixtures thereof and the like. Suitable examples in each class include, aromatic hydrocarbon solvents such as benzene, toluene and xylene; aliphatic hydrocarbon solvents such as pentane, hexane, octane or higher saturated hydrocarbons; ether solvents such as ethyl ether, butyl ether and tetrahydrofuran; ketone solvents such as methyl ethyl ketone; and halogenated hydrocarbon solvents such as trichloroethylene and mixtures thereof. Hexane is preferred.

Ebulation of oxygen can be used to insure that inhibitors maintain their effectiveness after reaction, thereby reducing unwanted polymerization of the final reaction product.

Generally, products of hydrosilylation reactions may be inexpensively and efficiently purified by distillation, or crystallization depending on their physical properties. However, high molecular weight liquids (400 grams per mole and greater) do not allow for either purification process and are typically enriched by liquid chromatography. It has been found that by using the hydrosilylation process of the present invention to form the silicon substituted glyceryl (meth)acrylate the desired product may be obtained substantially free from silicon containing impurities. This allows the reaction product to be readily purified by subjecting the first reaction product to treatment to remove compounds which are different in polarity from the silicon substituted glyceryl (meth)acrylate. Suitable treatments are known in the art and include solvent extraction (especially when ternary diagrams are generated), liquid chromatography, combinations thereof and the like. Where purification is required or desirable, solvent extraction is preferred. The use of solvent extraction to separate liquids of differing solubilities is well known in the art. Generally solvents are selected to provide two or more immiscible systems. The desired product should be substantially more soluble in one of the solvents, while the impurities to be removed are more soluble in the other solvent.

In case of polymerization of the silicon substituted glyceryl (meth)acrylate during purification (distillation or solvent evaporation), the polymerized silicon substituted glyceryl (meth)acrylate may be removed by precipitation, with or without ebulation.

In order to illustrate the invention the following examples are included. These examples do not limit the invention. They are meant only to suggest a method of practicing the invention. Those knowledgeable in contact lenses as well as other specialties may find other methods of practicing the invention. However, those methods are deemed to be within the scope of this invention.

The following abbreviations are used in the examples below:
SiMAA2 bis(trimethylsilyloxy)methylsilylpropylglycerol methacrylate (CA Index name is 2-propenoic acid, 2-methyl, 2-hydroxy-3-[3-[1,3,3,3-tetramethyl-1-[(trimethylsilyl)oxy]disiloxanyl]propoxy]propyl
MEHQ hydroquinone monomethyl ether
Epoxide (3-glycidoxypropyl)bis(trimethylsiloxy)methylsilane
MAA methacrylic acid
AHM allyloxy hydroxypropyl methacrylate
AGE allyl glycidyl ether
HMTS 1,1,1,3,5,5,5-heptamethyltrisiloxane

### EXAMPLE 1

To a three-neck, 250 mL round bottom reaction flask equipped with a magnetic stir bar, condenser with an attached drying tube, and a thermocouple, was added 25 g allyl glyceryl methacrylate (0.125 mol) and 100 mL hexanes, 25 g (0.112 mol). The flask was heated to 45° C., with stirring. Heptamethyltrisiloxane (1-2 mL) was added to the reaction mixture via the addition funnel, followed by a small spec of chloroplatinic acid. The remainder of the siloxane (a total of 25 g, 0.112 mol, including the original siloxane addition) was added dropwise, while maintaining the reaction temperature below 55° C. Once the exotherm was complete the reaction temperature was set to 50° C. and the consumption of the siloxane was monitored by thin layer chromatography.

After about six hours, the reaction mixture was removed from heat, allowed to cool ambient temperature and transferred to a 500 mL separatory funnel. The product was washed with:
1. 40 mL of 75/25 acetonitrile/water—a clear trilayer formed with the bottom layer enriched in water and the polar components of the reaction mixture. The second layer was enriched in acetonitrile, the polar impurities and a small amount of SiMAA2. The lower layers were removed and the hexanes fraction was retained in the funnel.
2. The hexanes fraction was washed with four portions (20 mL) of 75/25 acetonitrile/water. Each wash formed a trilayer with similar solute compositions as described in step 1.
3. The hexanes portion was washed 5 times with 50 mL portions of 95/5 acetonitrile/water. Each of these washes resulted in bilayer systems. The lower layer was enriched in SiMAA2 and contained very small amounts of the non-polar impurities. The total extracted volumes from the five washes was about 325-350 mL.
4. Hexanes (25 mL) were added to the combined extracts from step 3, which was then washed with 100 mL of water. A trilayer system was formed and the bottom layer was discarded.
5. The retained layers were washed twice using 50 mL of water, which resulted in a trilayer system. The bottom layer was discarded after each wash.
6. The retained layers were washed twice more with 25 mL portions of water.

The organic layer was then dried over 2 gm anhydrous Na₂SO₄ and 10 mg of methyl hydroquinone was added. The solution was filtered and remaining solvent was evaporated at 1-12 mbar and 55° C. The yield of SiMAA2 was about 63-65%, having a purity of 93-95%.

### EXAMPLE 2

To a three-neck, 5000 mL round bottom reaction flask equipped with a magnetic stir bar, condenser with an attached drying tube, and a thermocouple, was added 92 g dry lithium methacrylate (1 mol, 0.17 equivalents) and 1023 grams methacrylic acid (11.91 mol, 2 equivalents). MEHQ (4.65 g, 0.037 mol, 0.006 equivalents) was added to the reaction flask. To the stirred reaction mixture was added 2000 grams of Epoxide (obtained from Wright Corporation, 5.95 mol). The reaction mixture was heated to 90° C.

After about fifteen hours, the reaction mixture was removed from heat, allowed to cool to about 50° C. and transferred to a separatory funnel using ≈3200 mL hexanes (to give a 1:1 ratio of reaction mixture to hexanes) for transfer and to dilute the reaction mixture. The hexanes layer was washed successively with 4×≈3200 mL and 1×2000 mL 0.5 M aqueous NaOH, and 3×3200 mL 2.5 weight % aqueous NaCl. The organic layer was then dried over 250 gm Na₂SO₄ and filtered.

To the filtrate was added 800 g of flash grade silica gel. The heterogeneous mixture was agitated for three hours at room temperature and filtered over a fritted glass funnel. The filtrate was then concentrated on the rotary evaporator, at 55° C., to give SiMAA2. The resulting SiMAA2 was analyzed by LC-MS for purity. Purity results are listed in Table 1, below.

TABLE 1

| | Example 2 |
|---|---|
| Total Purity (%) | 85.9 |
| Difunctional impurities(%) | 4.92 |
| Ethyl Acetate(%) | <0.02 |
| Hexanes(%) | <0.06 |
| Epoxide(%) | 0.59 |
| Glycol(%) | 0.49 |

Difunctional impurities include the following compounds 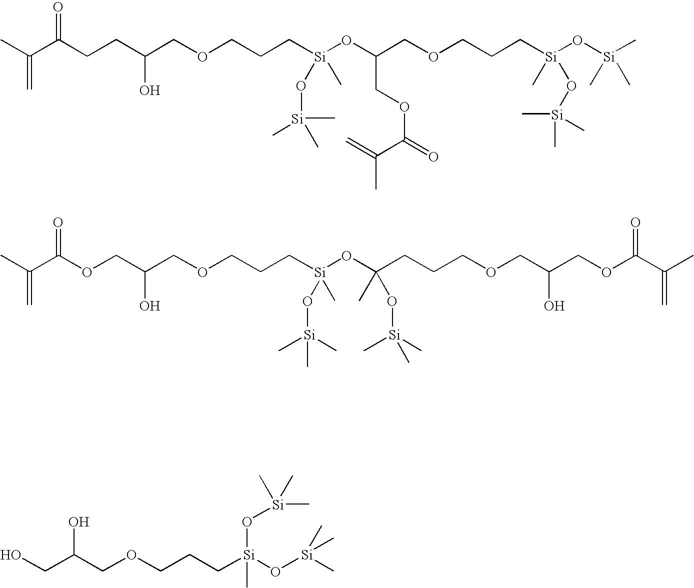
Accordingly, conventional processes yield a product containing a significant amount of silicone containing impurities.

### EXAMPLE 3

MAA, 99+% (231 g, 2.66 mol) was charged into a 3 necked 1000 mL dry round bottom flask containing a magnetic stir bar and equipped with a dry compressed air inlet and heat control sensor, a pressure equalizing addition funnel charged with AGE, 99+% (277.9 g, 2.41 mol), and a water cooled condenser connected to a bubbler. To the MAA, under dry compressed air, was added MEHQ, 99% (1.55 g, 9.2 mmol) followed by stirring for about 20 min until all the MEHQ went in solution. To the stirred solution was added lithium hydroxide, LiOH, 98% (6.41 g, 262.4 mmol) in two portions in 30 min intervals. The suspension was stirred for about 1 hour followed by raising the temperature to 70° C. over about 2 hours. The resulting clear solution was stirred for an additional 1 hour at 70° C. followed by dropwise addition of AGE at a rate of ˜11-12 drops/5 second. After addition, the reaction mixture was gradually heated to 90° C. in about 2 hours (with stepwise temperature increase) and stirred at 89±2° C. The reaction progress was monitored by taking an aliquot of the reaction mixture (suspension), filtering through a 0.45 micron filter, and analyzing by GC and GPC. After 20 hours, the resulting light yellow suspension was filtered through a sintered glass funnel (coarse frit) yielding 466.96 g (˜96.75%) of crude product as light golden yellow oil. The precipitate was washed with ethyl acetate (300 mL) in 5 portions and dried in air and vacuo yielding 19.68 g of the byproduct (lithium methacrylate) as white crystals. The collected filtrate was transferred into a separatory funnel along with 404.73 g of the above crude oil. The organic layer was washed with 400 mL of 0.25N NaOH+2.5% NaCl (2×), 400 mL of 5% NaCl (1×) dried with 100 g of anhydrous Na₂SO₄ and subsequently filtered through a glass sinter funnel (coarse frit). The filtrate along with 50 mL washings of ethyl acetate was evaporated rotary evaporator at ˜30° C., followed by drying in vacuo. The process yielded 376.13 g of AHM (92.93%)

To 120.05 g of the AHM produced above, was added 0.12 g (1000 ppm) of MEHQ and distilled at ˜61 C(CHCl₃ reflux) under 1.5-2 mbar. Two fractions were obtained: High boiling residue, 99.07 g (82.52%) of yellow oil and Low boiling distillate, 13.62 g of colorless oil.

97.99 g of the above low boiling distillate was molecularly distilled at ˜80° C. using a Falling Film Evaporator (MEK reflux) under 0.8-1 mbar yielding two fractions: Low boiling distillate, 91.19 g (93.06%) of clear colorless purified AHM and High boiling residue, 3.18 g of yellowish brown viscous oil. The total overall yield of AHM was about 69.04%.

### EXAMPLE 4

MAA, 99+% (80.75 g, 928.5 mmol) was charged into a 3 necked 500 mL dry round bottom flask containing a magnetic stir bar and equipped with a dry compressed air inlet and heat control sensor, a pressure equalizing addition funnel charged with AGE, (99+%) (128.47 g, 1114.3 mmol), and a water cooled condenser connected to a bubbler. To the MAA, under dry compressed air, was added BHT (99%) (0.33 g, 1.5 mmol) followed by stirring for about 5 minutes until all the BHT went in solution. To the stirred solution was added LiOH (98%) (2.2 g, 90 mmol) in two portions in 10 minute intervals. The suspension was gradually heated to 70° C. over about 2 hours. The resulting clear solution was stirred for an additional 2 hours at 70° C. followed by dropwise addition of AGE keeping addition rate of ˜5 drops/5 second. After addition, the reaction mixture was gradually heated to 80° C. over about 2 hours (with stepwise temperature increase) and stirred at 80±2° C. The reaction progress was monitored by taking aliquots of the reaction mixture (suspension), filtering through a 0.45 micron filter, and analyzing by GC and GPC. After 23 hours, with total consumption of MAA noted by GC analysis, the reaction mixture was brought to room temperature and the resulting light yellow suspension was filtered through a glass fritted (coarse) funnel yielding 171.95 g of the filtrate and 7.85 g of white crystalline solid. To 99.99 g of the above filtrate was added 0.02 g of BHT and 99.19 g of the mixture was purified using a falling film evaporator (FFE) under vacuum between 1.8-1.9 mbar at ˜61° C. (using refluxing CHCl₃) yielding 76.68 g (˜77.3%) g of amber yellow residue and 10.92 g of distillate. To 75.84 g the above residue was added 0.075 g of BHT and 74.5 g of the mixture was passed again through the FFE vacuum between 1.8-1.9 mbar at ˜80° C. (using refluxing MEK) yielding 42.42 g (˜56.94%) of pure AHM in the distillate as colorless oil and 27.63 g of residue.

The analytical results of experiments screened using different reactant ratios, type and concentration of inhibitor, catalyst concentration, time, and temperature are summarized in Table 1, below.

| Ex. # | Yield | Purity-GC % | Purity-GPC % |
|---|---|---|---|
| 3 | 69 | 97.2 | 99.2 |
| 4 | 60 | 91.6 | 99.5 |

### EXAMPLE 5

Into a 250 ml round bottle flask equipped with a magnetic stirrer, a nitrogen inlet, an additional funnel, a thermocouple connected to a controller, and a nitrogen outlet connected to a bubbler was charged 11.9 g (60 mmole) of AHM, produced according to Example 3 (containing 3000 ppm of 4-methoxyphenol). The flask was then placed in an ice water bath followed by addition, under nitrogen, platinum(0) 1,3-divinyltetramethyldisiloxane complex to give 10 ppm platinum metal relative to AHM. After stirring for 5 minutes with nitrogen bubbling, a small amount of 1,1,1,3,5,5,5-heptamethyltrisiloxane from the total 11.1 g (50 mmole) was added to the flask through the additional funnel. After confirming the initiation of the reaction, the rest of 1,1,1,3,5,5,5-heptamethyltrisiloxane was added drop-wise to the flask over a period of 1 hour. The flask was kept at ice water temperature (0° C.) for 20 hrs under stirring. Upon 97% conversion of 1,1,1,3,5,5,5-heptamethyltrisiloxane, evidenced by GC analysis, and the absence of high molecular weight species, detected by GPC analysis, the selectivity of the reaction was confirmed and course of the reaction considered complete.

### EXAMPLES 6-9

The reaction, formulation and conditions were kept the same as Example 5 except for the temperature, which was varied as shown in Table 2, below. The GC and GPC analytical results of reaction samples taken at 20 hours reaction time are summarized in Table 2.

TABLE 2

| | Ex# | | | | |
|---|---|---|---|---|---|
| | 6 | 7 | 8 | 9 | 5 |
| React. | 70 | 45 | 21(rt) | 17(water | 0 (ice |
| temp. ° C. | | | | bath) | water) |
| | | | | | to 17 |
| SiMAA2 | Partially | 64.2 | 74.9 | 78.5 | 72.6 |
| by GC, % | polymerized | | | | |
| Bi-product | Partially | 28.9 | 6.12 | 9.6 | 3.8 |
| by GC, % | polymerized | | | | |
| SiMAA2 | Partially | 65.8 | 74.5 | 76.7 | 70 |
| by GPC, % | polymerized | | | | |
| HMW bi-product | Partially | 22.1 | 8.9 | 2.9 | 0.9 |
| by GPC, % | polymerized | | | | |

The results demonstrated that the catalyst selectivity significantly improves at temperatures of about 20° C. and lower.

### EXAMPLE 10

The crude product from Example 5 was subjected to wiped film distillation using a residence time of less than one minute and a temperature of about 60° C. After one pass the product contained 8.5 wt % AHM.

The crude that containing about 8.5% of AHM residual was then subjected to liquid-liquid extractions using ethylene glycol as the solvent. It was found that AHM was completely soluble in ethylene glycol and SiMAA2 is almost insoluble in ethylene glycol. As demonstrated in Table 3, AHM was reduced from 8.66% to <0.1% after 5 ethylene glycol extractions with solvent to extractant ratio (by weight) of 4 to 1.

TABLE 3

| # of extraction | |
|---|---|
| (solvent/extractant = 4/1) | AHM, % by GC |
| 0 | 8.66 |
| 1 | 3.47 |
| 2 | 1.32 |
| 3 | 0.51 |
| 5 | 0.07 |

### EXAMPLE 11

To a 250 ml round bottle flask equipped with a mechanical stirrer, a thermocouple connected to a controller, a dry air inlet connected with a dip tube, a Dean-Stark trap and a condenser, was charged with 1.9 g (80 mmole) of lithium hydroxide, 0.3 g (2.5 mmole) of 4-methoxyphenol, 68.9 g (800 mmole) of MMA. The flask was slowly heated to 80° C. to dissolve the lithium hydroxide while dry compressed air was purged through the catalyst solution to remove water generated from acid-base reaction. The purging was continued until the water content was less than 500 ppm by Karl Fisher titration.

The catalyst solution was cooled to ambient temperature and 134.5 g (400 mmole) of (3-glycidoxypropyl) heptamethyltrisiloxane was added, followed by slowly raising the temperature to 80° C. After most of the exothermic reaction was completed, the flask was heated to 90° C. and maintained for about 20 hours while dry air was bubbled through the flask. When the concentration of (3-glycidoxypropyl) heptamethyltrisiloxane was less than 0.2% by GC, 7 ml of DI water was added to the mixture to convert the trimethylsilated compound back to the product SiMAA2. The crude mixture was cooled to room temperature and then diluted with hexane (1:1 in volume). The organic mixture was then washed with 0.4N NaOH/2.5 w/v % NaCl aqueous solution until the aqueous phase became basic. The organic phase was then washed with 4×170 ml of 2.5 w/v % NaCl aqueous solution. The organic phase was carefully separated, dried over Na₂SO4 overnight, and slurry treated with 9×10 g silica gel. The volatiles were removed by rotary evaporator. The SiMAA2 product thus obtained has a HPLC purity of ≧90% with about 60% yield.

We claim:

1. A process comprising the step of reacting, in the presence of a hydrosilylation catalyst, a first reaction mixture comprising at least one free radical reactive compound and a silicon containing compound of the formula
HSiR²R³R⁴
wherein R², R³ and R⁴ are independently selected from alkyl groups having 1 to 12 carbons, substituted and unsubstituted benzene and toluene groups, and —OSiR⁵R⁶R⁷ wherein R⁵, R⁶ and R⁷ are independently selected from the group consisting of straight or branched alkyl groups having 1 to 12 carbon atoms and substituted or unsubstituted phenyl or benzyl rings to form a silicon substituted glyceryl (meth)acrylate.

2. The process of claim 1 wherein said hydrosilylation catalyst is selected from group consisting of platinum, platinum supported on a solid carrier, chloroplatinic acid, complexes of chloroplatinic acid with alcohols, aldehydes and ketones, platinum-olefin complexes; platinum-vinyl siloxane complexes; platinum-phosphine complexes; platinum-phosphite complexes, dicarbonyl dichloroplatinum, platinum-hydrocarbon complexes, platinum-alcoholate catalysts and combinations thereof.

3. The process of claim 1 wherein said hydrosilation catalyst is selected from group consisting of RhCl(PPh₃)₃, RhCl₃, Rh/Al₂O₃, RuCl₃, IrCl₃, FeCl₃, AlCl₃, PdCl₂≅2H₂O, NiCl₂ and TiCl₄ and combinations thereof.

4. The process of claim 1 wherein said hydrosilylation catalyst is selected from group consisting of chlorides of platinum, vinyl complexes of platinum and combinations thereof.

5. The process of claim 1 wherein said hydrosilylation catalyst comprises chloroplatinic acid.

6. The process of claim 1 wherein at least two of R², R³ and R⁴ are the same and are selected from alkyl groups having 1 to 12 carbon atoms.

7. The process of claim 1 wherein at least two of R², R³ and R⁴ are the same and are —OSiR⁵R⁶R⁷.

8. The process of claim 1 wherein R², R³ and R⁴ are selected from straight or branched alkyl groups having 1 to 8 carbon atoms.

9. The process of claim 1 wherein R², R³ and R⁴ are selected from straight or branched alkyl groups having 1 to 4 carbon atoms.

10. The process of claim 1 wherein at least two of R², R³ and R⁴ are the same and are selected from straight or branched alkyl groups having 1 to 8 carbon atoms.

11. The process of claim 1 wherein at least two of R², R³ and R⁴ are the same and are selected from straight or branched alkyl groups having 1 to 4 carbon atoms.

12. The process of claim 7 wherein at least two of R⁵, R⁶ and R⁷ are the same and are selected from straight or branched alkyl groups having 1 to 8 carbon atoms.

13. The process of claim 7 wherein at least two of R⁵, R⁶ and R⁷ are the same and are selected from straight or branched alkyl groups having 1 to 4 carbon atoms

14. The process of claim 1 wherein said temperature is between about −20° C. and about 100° C.

15. The process of claim 1 wherein said temperature is between about −10° C. and about 60° C.

16. The process of claim 1 wherein said process is conducted for a reaction time between about 1 and about 24 hours.

17. The process of claim 1 wherein said process is conducted for a reaction time between about 4 and about 12 hours.

18. The process of claim 1 wherein said at least one free radical reactive compound is of the formula 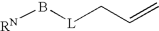
wherein R^{N} is selected from moieties having the formulae II and III: 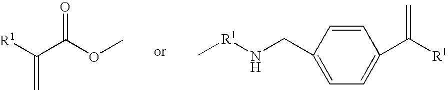
B is selected from the group consisting of hydrogen bonding groups and carboxylic acid derivatives;
L is a linking group selected from the group consisting of a direct bond, hetero atoms and straight or branched alkylenes having 1 to 6 carbon atoms.

19. The process of claim 18 wherein B is selected from the group consisting of carbonyl, alkylene having 1 to 6 carbon atoms which may be unsubstituted or substituted with hydroxy, amines, amides, ethers, esters, aldehydes, ketones, aromatics, alkyl groups and combinations thereof.

20. The process of claim 18 wherein L is a hetero atom selected from O, N or S; B is a hydroxyl substituted alkyl group having 1-4 carbon atoms and R¹ may be the same or different, and is independently selected from H and alkyl groups having 1 to 4 carbon atoms.

21. The process of claim 1 wherein said free radical reactive compound is

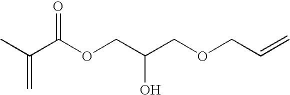

22. The process of claim 1 wherein said process further comprises the step of treating said first reaction product to remove compounds which are more polar than said silicon substituted glyceryl (meth)acrylate.

23. The process of claim 1 wherein said temperature is between about −10° C. and about 30° C.
